(19) United States
(12) Patent Application Publication
(10) Pub. No.: US 2013/0186240 A1
(43) Pub. Date: Jul. 25, 2013

(54) Adjustable Jar Opener

(71) Applicant: Lawrence Donahue, Rancho Palos Verdes, CA (US)

(72) Inventor: Lawrence Donahue, Rancho Palos Verdes, CA (US)

(21) Appl. No.: 13/355,558

(22) Filed: Jan. 22, 2012

(51) Int. Cl. B67B 7/18

(52) U.S. Cl. 81/3.44

(57) ABSTRACT

A adjustable jar opener comprising a pair of handles and a pivot connecting the handles is described herein. The pivot provides movement of the handles to rotate relative to each other and the pivot can be disengaged and re-engaged allowing one handle to slide along a blade increasing or decreasing in size to accommodate a variety of jar and bottle sizes. The pivot generally remains engaged by the action of a spring. Rubber grips used on the handles provide compliance between the jar opener and the jar or bottle lid and to increase the contact friction between the jar or bottle and the jar opener.

### FIELD OF INVENTION The present invention is a device for removing or retightening lids of jars, caps of twist top bottles and similar tasks.

### BACKGROUND OF INVENTION

Many jar openers have been designed and produced, but none have been widely adopted. Many people still struggle with opening of jars and bottles. The present invention is a simple straightforward device that most people will be able to conveniently use in their kitchen and store in a kitchen drawer.

This invention will adjust for many different sizes and allow the jar or bottle to be opened with a squeeze and twist motion. The invention mechanically multiplies the gripping force and torque on the jar lid to assist in opening tightly sealed jars.

### SUMMARY OF THE INVENTION

This invention provides for a jar opener comprising two handles, a spring loaded pivot mechanism, an adjustment bar and rubber grips. The pivoting mechanism can be disengaged by pressing on the knob of the pivot mechanism with the thumb and when disengaged one handle of the jar opener can be slide closer or further away from the other handle along the adjustment bar. Releasing the thumb from the knob allows the spring to reengage the pivot mechanism.

The handles have rubber grips for engagement of the jar and bottle lids against the handles of the jar opener. The handles pivot in a fashion such that they act as levers and increase the force exerted for engaging the jar or bottle lid.

The adjustment bar is a permanent part of one handle of the two handle pair. The adjustment bar is fixed to this handle with fasteners, adhesively bonded or integrally formed causing the handle and adjustment bar to function a single unit. The other handle is split on one end so as to allow the adjustment bar to slide between the prongs in this second handle.

### BRIEF DESCRIPTION OF DRAWINGS

The invention can be more particularly described, by way of example only, with reference to these drawings, in which;

FIG. 1 is an isometric view of a preferred embodiment of the invention

FIG. 2 is an isometric view of the adjustable jar opener positioned on a jar

FIG. 3 is a front view of the adjustable jar opener

FIG. 4 is cross section 4-4 showing the button bolt and cylindrical nut with the lever

FIG. 5 is a back view of the adjustable jar opener

FIG. 6 is a top view of the adjustable jar opener

### DETAILED DESCRIPTION OF PREFERRED EMBODIMENT

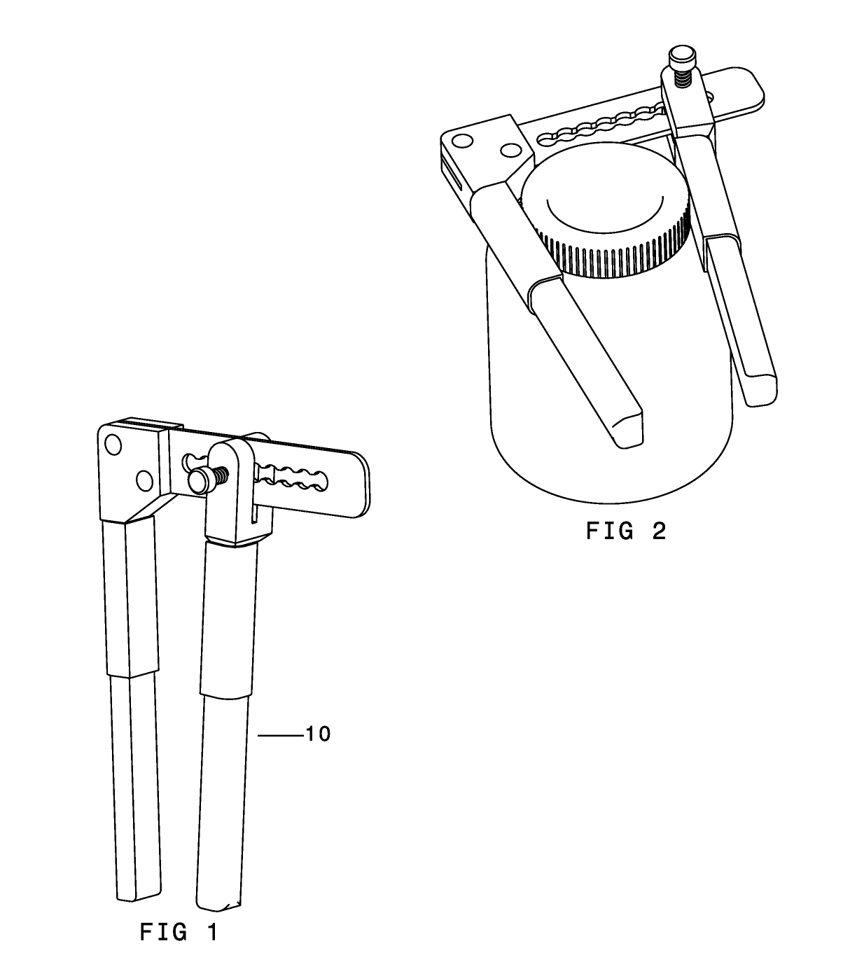

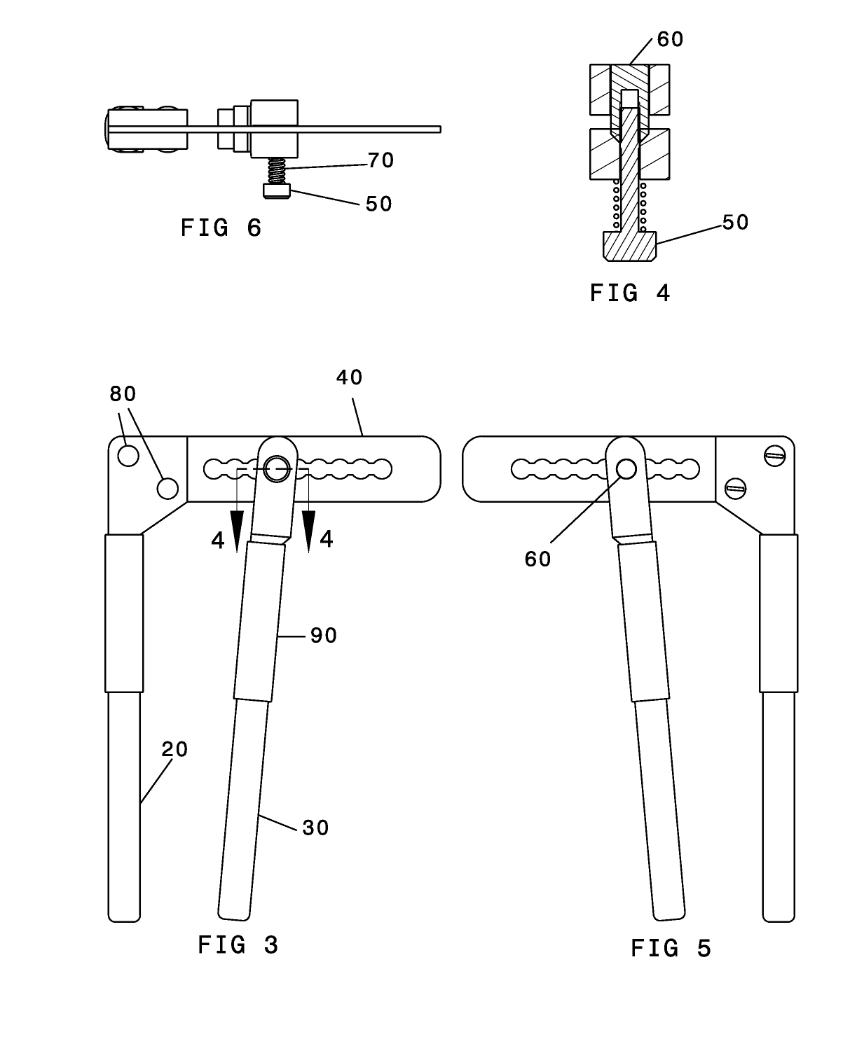

Referring to the drawings there is shown an adjustable jar opener 10 embodying the invention. FIG. 1 is an isometric view of the jar opener configured for loosening or tightening a jar or a bottle. An adjustable jar opener 10 embodying the invention includes two leveraging elements a handle 20 and a lever 30 each of handle 20 and lever 30 have a grip 90 wrapped around them. Lever 30 has a hole near one end that serves as a pivot point for lever 30. The handle 20 is connected to a blade 40 by two fasteners binding posts 80. The blade 40 has a multitude of interconnected holes for locating the pivot point of lever 30. The large holes in blade 40 are interconnected by a slot the width of the interconnecting slot is much smaller than the diameter of the holes in blade 40. The pivot point of the lever 30 is connected to the blade 40 by a button bolt 50. The button bolt 50 and a cylindrical nut 60 attached to button bolt 50 holds the assembly together. Button bolt 50 passes through a spring and keeps the cylindrical nut 60 engaged in lever 30 and blade 40 providing a fixed center for lever 30 to rotate about.

Pushing on button bolt 50 compresses spring 70 and disengages cylindrical nut 60 from a large diameter hole in blade 40 and allows the smaller diameter of button bolt 50 to be pushed laterally into the hole of blade 40 allowing the smaller diameter button bolt 50 to slide along the slot of interconnecting holes in blade 40. The lever 30 cylindrical nut 60 and spring 70 also slide together with button bolt 50 as an assembly. Releasing pressure allows the spring 60 to push button bolt 50 to its released position and pull cylindrical nut 60 into the engaged position with lever 30 and blade 40.

Handle 20 is a wooden, plastic or metal bar with one side flat for engagement against the jar lid. One end is enlarged to provide room for fasteners that connect handle 20 to blade 40. The other end is rounded and smooth for ergonomics. Grip 90 is fitted over the handle 20 at ¾ the length in the position where the jar lid will be placed in adjustable jar opener 10. The grip 90 is preferable made of latex rubber to ensure the surface has a high coefficient of friction but other suitable plastics like silicon rubber or materials with high friction surfaces can be used.

Binding posts 80 are used to fasten handle 20 to blade 40. The preferred embodiment is shown with binding post 20 fasteners. This fastener is from a category often referred to as binding post or sex bolts and sometime Chicago bolts. Other suitable fasteners are cutlery rivets, standard rivets or a nut and bolt combination.

Blade 40 of the preferred embodiment is constructed of aluminum bar stock. Blade 40 has a series of holes in sequence that are interconnected by a slot. The slot is made slightly larger than the shaft diameter of button bolt 50 allowing button bolt 50 to slide along the slot of blade 40. The interconnected holes of blade 40 are slight larger than cylindrical nut 60 allowing cylindrical nut 60 to move into any one of the interconnected holes of blade 40 locking the pivot point of lever 30 into a particular position along the length of blade 40.

Lever 30 is a wooden, plastic or metal rod with one side flat for engagement against the jar lid. One end is enlarged to provide room for concentric holes for button bolt 50 and nut 60 to slide through in coordination to each other. The other end is rounded and smooth for ergonomics. Grip 90 is fitted over the lever 30 at ¾ the length in the position where the jar lid will be placed in adjustable jar opener 10. The elongated handle portion of lever 30 is nearly a mirror image of the elongated handle end of handle 20. These two parts provide the location where the jar lid is placed and the adjustable jar opener 10 is gripped by a person to twist the jar lid. The two grips 90 one each on handle 20 and lever 30 are aligned with each other. The enlarged end of lever 30 contains a slot forming the shape of a fork in this end of lever 30. The slot is slightly wider than the thickness of blade 40 and allows blade 40 to be slide through this fork shaped end. Perpendicular to this slot is a hole in the fork end of lever 30. The hole is bisected by the slot. On one side of the fork the hole is approximately the size but larger than the diameter of the shaft portion of button bolt 50. Concentric with this hole but located on the other side of the fork is another hole that provides a space in which Cylindrical nut 60 can reside. Naturally this hole is approximately the size but larger than the diameter of cylindrical nut 60.

Cylindrical nut 60 and button bolt 50 are connected to each other with internal and external threads. Button bolt 50 slides inside one end of the holes in the fork prongs of lever 30 and is surrounded by spring 70. The large button end of button bolt 50 is large enough to entrap spring 70 under the head of button bolt 50 and against one side surface of lever 30. Cylindrical nut 60 resides in the other end of the concentric holes in the fork prongs and is thread to button bolt 50. The interconnected button bolt 50 and cylindrical nut 60 pass through the holes and slot in blade 40. Spring 70 reacts against under side of Lever 30 and the underside of button bolt 50 thus pulling cylindrical nut 60 into a particular hole of blade 40 and selecting a pivot point for lever 30. Button bolt 50 can be crafted from steal, stainless steel, brass, bronze plastic or other material. Cylindrical nut 60 can be crafted from steal, stainless steel, brass, bronze, plastic or other material. Spring 70 can be made from any suitable spring material and can be several different forms; a wound compression spring, a flat or curved cantilever spring a flat wire wave spring and other forms. In this preferred embodiment a wound compression spring is used.

Adjustable jar opener 10 is use to open or close jars and bottles by first adjusting the distance between handle 20 and lever 30. In order to adjust this distance button bolt 50 is pushed and lever 30 is slide along the blade 40. Button bolt 50 is released to lock lever 30 into position. The jar or bottle to be opened is placed between the grip 90 of handle 20 and the grip 90 of lever 30. Using one hand the handle 20 and lever 30 are squeezed together and the other hand is used to hold the jar. Finally the adjustable jar opener 10 is twisted while still squeezing in order to twist off the jar lid. Twisting adjustable jar opener 10 counter clockwise will loosens common lids and twisting clockwise will tighten common lids.

The invention had been given by way of example only and various modifications of and/or alterations to the described embodiment may be made by persons skilled in the art without departing from the scope of the invention as specified in the appended claims.

The invention claimed is:

1. An opener for opening containers with threaded closures using human force, the opener comprising:
A handle and a lever each with a portion of its surface having a latex rubber section for contact against a jar lid or bottle top, the handle has a right angle bend formed by the fixed attachment of a thin blade and the lever has one end bifurcated creating the shape of a fork allowing the blade portion of the handle to pass through the fork section of the lever, each prong of the fork has a concentric hole for a pin to serve as the pivot point for the lever, the lever and handle are interconnected by this pivot pin which is spring loaded and the blade has numerous holes with a slot connecting the holes, the pivot pin passes through one of two concentric holes of the fork end of the lever, through the slot in the blade of the handle and through the second concentric hole on the fork end of the lever, the pivot pin is secured in place with a nut on one side of the pivot pin and an enlarged head on the other side of the pin, a compression spring is concentrically placed around the pivot pin and trap between the enlarged head of the pivot pin and the side of the forked end of the lever, the pivot pin has 2 different diameters along the length of the pivot pin one diameter is sized to engage the numerous holes in the blade and the other diameter is sized to slide along the slot interconnecting the holes on the blade.

2. An opener for opening containers with threaded closures using human force, the opener comprising:
A handle and a lever each with a portion of its surface having a resilient plastic section for contact against a jar lid or bottle top, the handle has a right angle bend formed by the fixed attachment of a thin blade and the lever has one end bifurcated creating the shape of a fork allowing the blade portion of the handle to pass through the fork section of the lever, each prong of the fork has a concentric hole for a pin to serve as the pivot point for the lever, the lever and handle are interconnected by this pivot pin which is spring loaded and the blade has numerous holes with a slot connecting the holes, the pivot pin passes through one of two concentric holes of the fork end of the lever, through the slot in the blade of the handle and through the second concentric hole on the fork end of the lever, the pivot pin is secured in place with a nut on one side of the pivot pin and an enlarged head on the other side of the pin, a compression spring is concentrically placed around the pivot pin and trap between the enlarged head of the pivot pin and the side of the forked end of the lever, the pivot pin has 2 different diameters along the length of the pivot pin one diameter is sized to engage the numerous holes in the blade and the other diameter is sized to slide along the slot interconnecting the holes on the blade.

3. An opener for opening containers with threaded closures using human force, the opener comprising:
A handle and a lever each with a portion of its surface having a roughed or knurled surface section for contact against a jar lid or bottle top, the handle has a right angle bend formed by the fixed attachment of a thin blade and the lever has one end bifurcated creating the shape of a fork allowing the blade portion of the handle to pass through the fork section of the lever, each prong of the fork has a concentric hole for a pin to serve as the pivot point for the lever, the lever and handle are interconnected by this pivot pin which is spring loaded and the blade has numerous holes with a slot connecting the holes, the pivot pin passes through one of two concentric holes of the fork end of the lever, through the slot in the blade of the handle and through the second concentric hole on the fork end of the lever, the pivot pin is secured in place with a nut on one side of the pivot pin and an enlarged head on the other side of the pin, a compression spring is concentrically placed around the pivot pin and trap between the enlarged head of the pivot pin and the side of the forked end of the lever, the pivot pin has 2 different diameters along the length of the pivot pin one diameter is sized to engage the numerous holes in the blade and the other diameter is sized to slide along the slot interconnecting the holes on the blade.
